(19) United States
(12) Patent Application Publication
(10) Pub. No.: US 2012/0087131 A1
(43) Pub. Date: Apr. 12, 2012

(54) LIGHTING DEVICE

(76) Inventors: Enrique Rota Jovani, Barcelona (ES); María Asunción Sala Cruells, Barcelona (ES)

(21) Appl. No.: 13/375,919

(22) PCT Filed: Jun. 2, 2010
(86) PCT No.: PCT/ES10/00243

§ 371 Date: Dec. 2, 2011

(30) Foreign Application Priority Data
Jun. 4, 2009 (ES) P2009390264

(51) Int. Cl. F21V 11/04; F21V 11/02

(52) U.S. Cl. 362/279; 362/290

(57) ABSTRACT

Movable lighting device for lighting interiors, characterized in that it consists of a three-dimensional geometric body that has translucent or transparent faces, inside which is a light source, and in that the lateral faces thereof have horizontal-slat Venetian-type blinds.

This invention relates to a mobile lighting device.

In particular, this invention relates to a lighting device providing a novel and aesthetically effective type of illumination, of simple structure.

Document FR 1537069 A discloses a cylindrical lamp comprising a bulb surrounded by vertical fixed locating slats which are nevertheless able to rotate, bringing about an effect of modulating the intensity of the light by alternating zones of more intense illumination with others of less intense illumination according to a circumferential distribution around the lamp. This lamp has a number of disadvantages, for example that it is not possible to choose the distribution of intensities on the basis of height, nor is it possible to obtain maximum uniform illumination if necessary.

In order to overcome these disadvantages the mobile lighting device for the illumination of interiors to which this invention relates comprises a three-dimensional geometrical body having translucent or transparent faces in the interior of which there is a source of light, in which the lateral faces have blinds of the venetian-blind type comprising horizontal slats.

Blinds of slats have the advantage that they subdivide and diffuse the rays of light from the light source, offering illumination which is highly appreciated by users. Furthermore the slats reflect part of the light which might leave through the top of the lighting device, achieving an effective illumination without a high intensity of light.

Another advantage lies in the fact that a blind of slats makes it possible to regulate the intensity of the light, both by varying the angle of the slats and through the ability to gather up/deploy the blind.

In a highly useful variant the slats of the blinds have holes or areas on their surfaces which allow light to pass from the interior of the lighting device, bringing about a graduated effect in both intensity and the refraction and reflection caused by the slats.

To provide the light with means to regulate intensity, the lighting device preferably has at least one control to vary the spatial orientation of the slats and more preferably a control to raise and lower the blinds.

In a preferred embodiment the blinds of slats are located in a space defined by two transparent sheets, such as translucent or transparent glass.

As to their geometrical shape, this may be of any kind, for example parallelepipedic, essentially pyramidal (or other type of polyhedron), cylindrical, etc.

In general the device to which this invention relates provides a gradation of the intensity of the light, and the possibility of choosing its distribution according to the height of the room in which it is located.

For a better understanding drawings of preferred embodiments of this invention are provided by way of an explanatory but not limiting example.

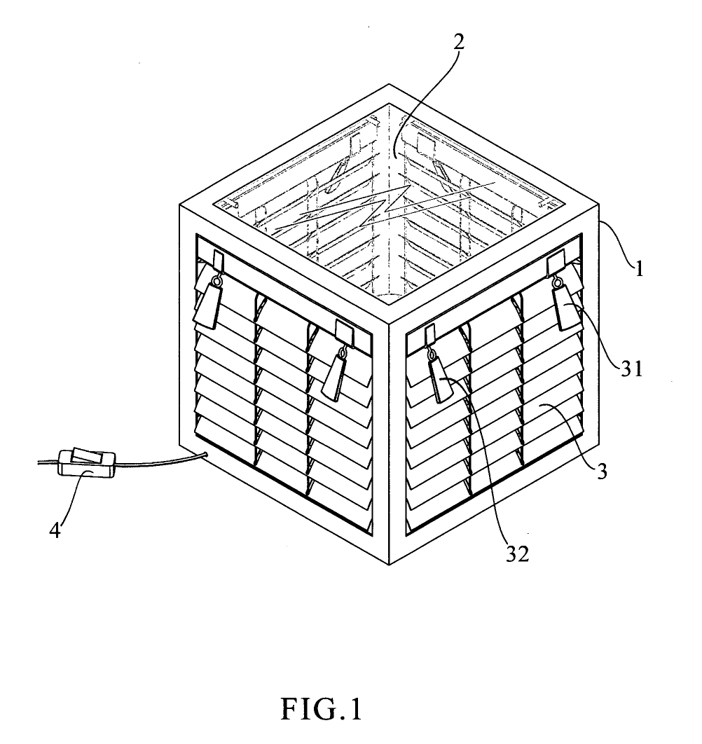

FIG. 1 is a perspective view of an embodiment of a lighting device according to this invention.

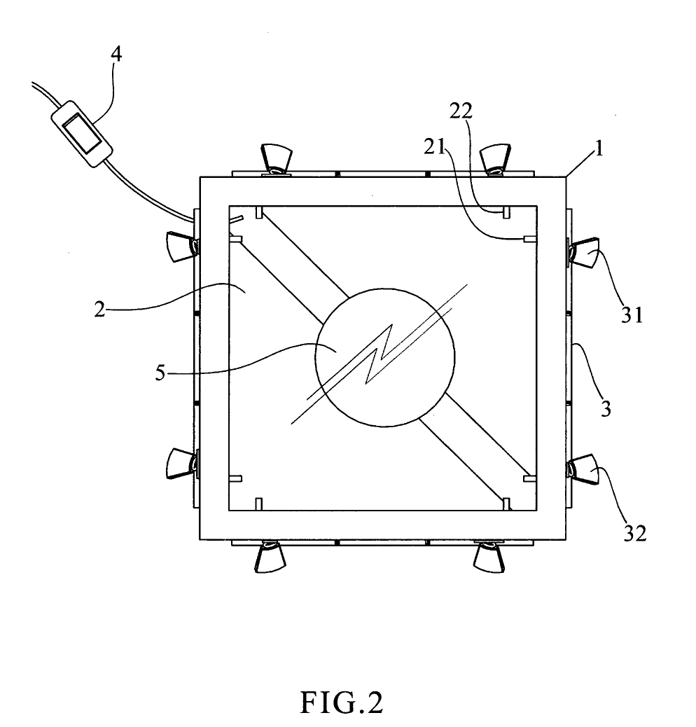

FIG. 2 is a plan view for above of the embodiment in FIG. 1.

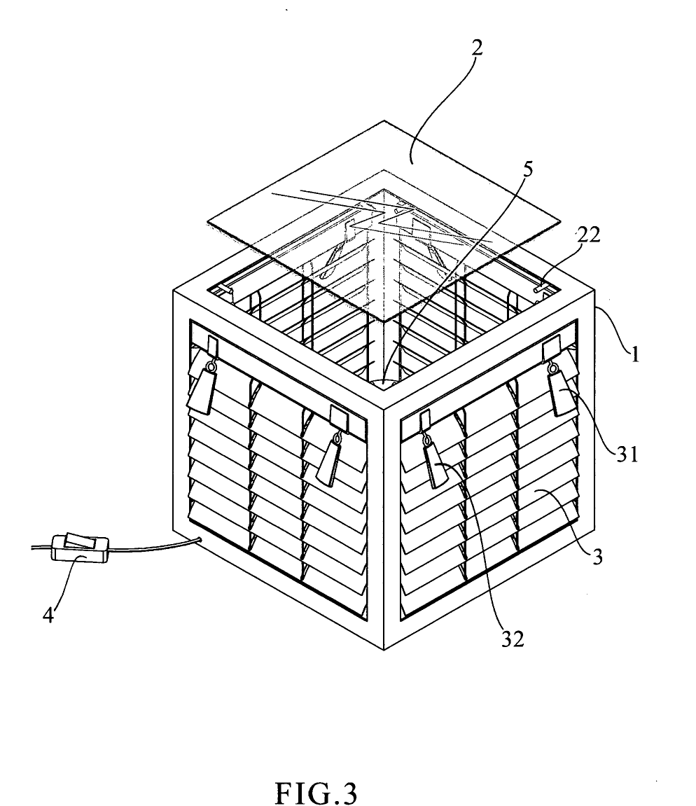

FIG. 3 is a perspective view in which the top end member has been raised.

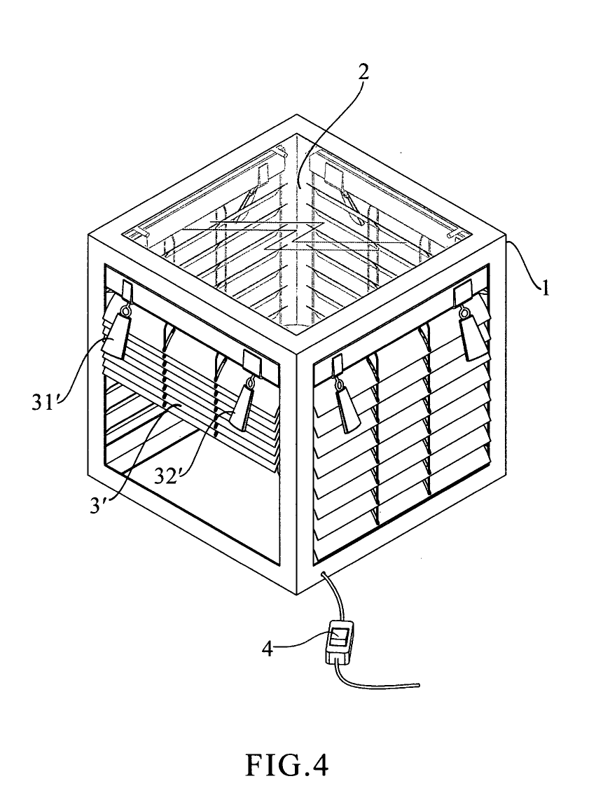

FIG. 4 is another perspective view in which one of the blinds has been raised.

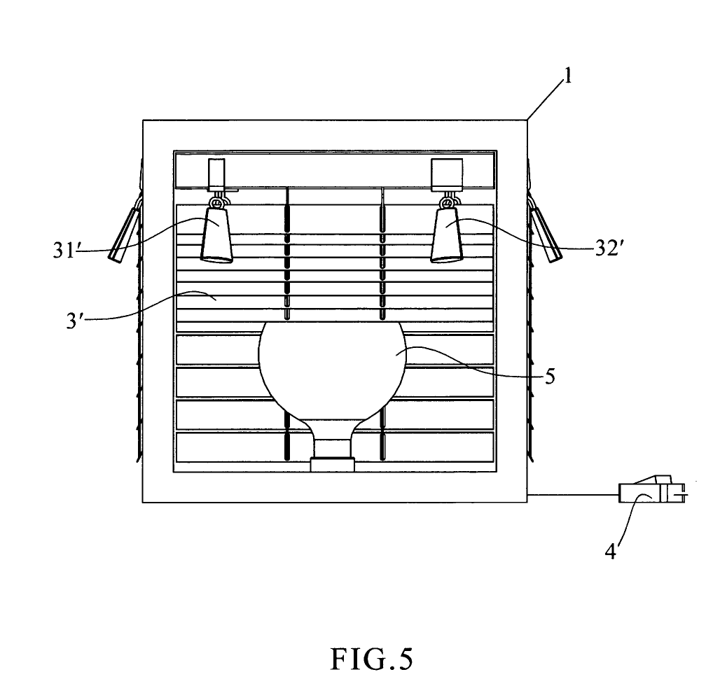

FIG. 5 is a view in lateral elevation with the said blind in the raised position.

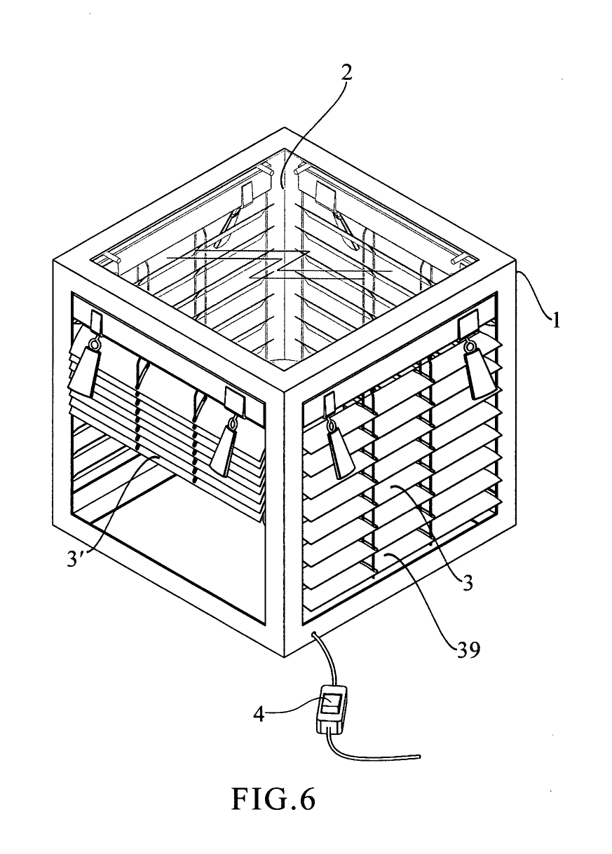

FIG. 6 is another perspective view similar to that in FIG. 4, in which the orientation of the slats in the other blind has been varied.

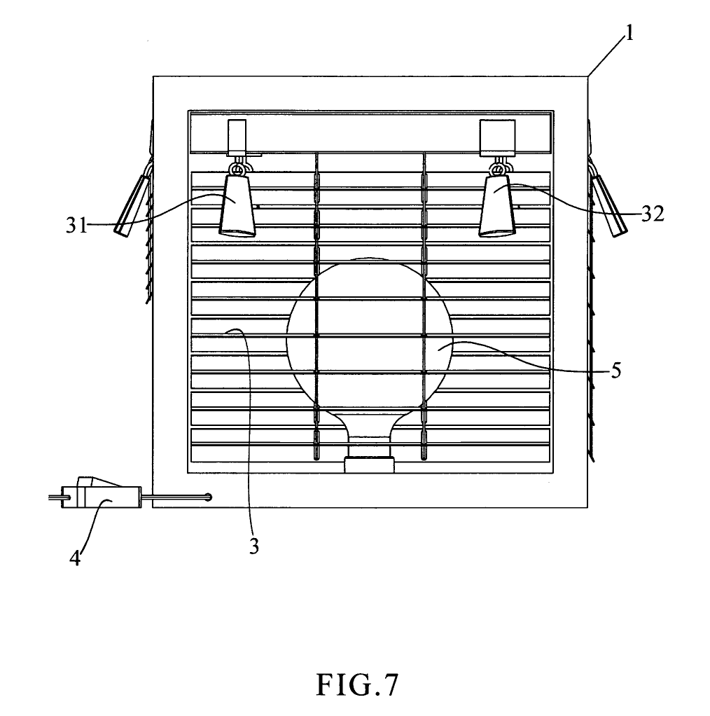

FIG. 7 is a view in lateral elevation, with the said blind with the slats rotated.

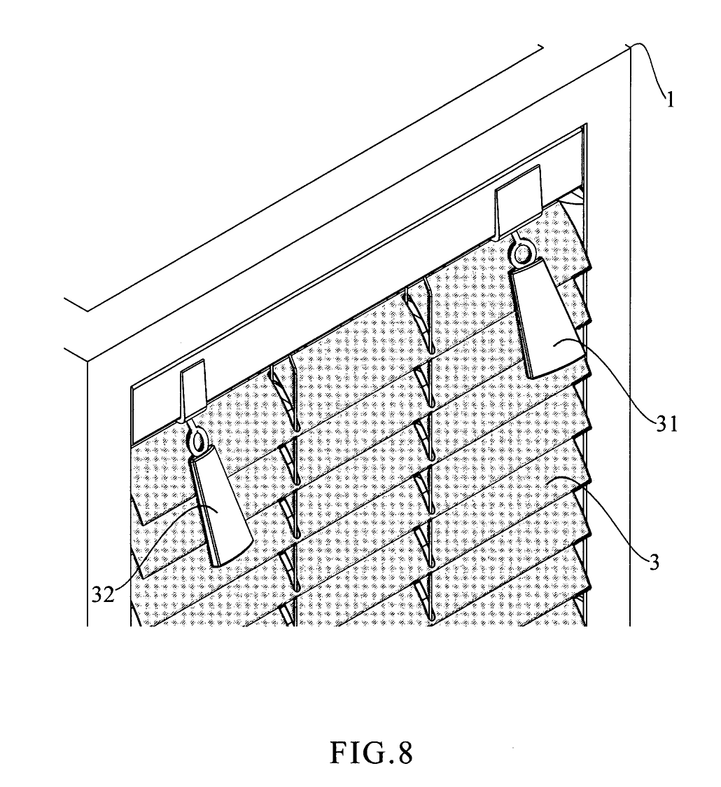

FIG. 8 is a detailed view showing an alternative embodiment of the slats, with opaque and semi-transparent zones.

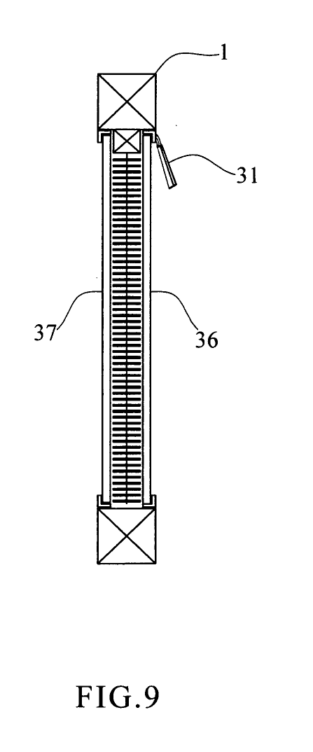

FIG. 9 shows a diagram of an alternative embodiment comprising fitting of the blinds between two panes of glass.

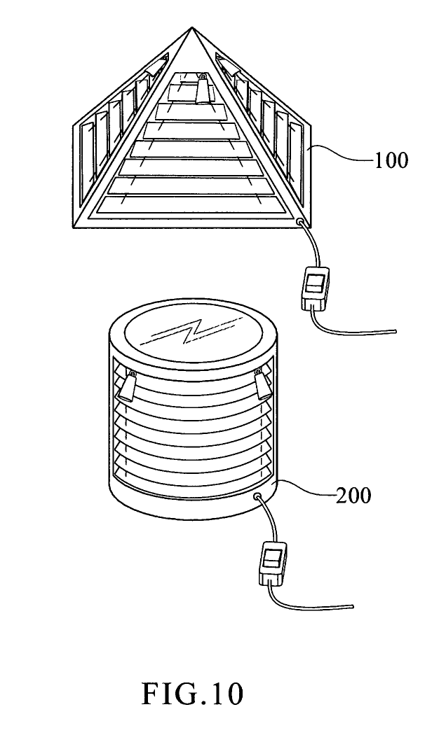

FIG. 10 shows two alternative embodiments of the lighting device having pyramidal and cylindrical shapes.

An embodiment of a lighting device or lamp to which this invention relates is illustrated in FIGS. 1 to 7.

The lighting device comprises a skeleton -1- forming a parallelepipedic shape, in particular a cube. The lateral faces of the cube are covered by venetian blinds -3-, -3′- with their corresponding controls -31-, -32-, -31′-, -32′- to lower/raise the blinds and to rotate the slats of the venetian blinds, according to known techniques. The top end is covered by a translucent laminar plate -2- supported by projections -21-, -22- of skeleton -1-.

Within there is a bulb -5- which is the source of light chosen for this embodiment. The lighting device also has a switch/control -4-.

FIG. 8 shows a variant in which the slats of blind -3- have zones which are to a greater or lesser extent opaque. A similar effect may also be achieved through holes in the slats, which allow greater illumination power without losing the special characteristics of the illumination.

FIG. 9 shows a diagrammatical example of how blinds -3- may be fitted between two transparent sheets -36-, -37-. This arrangement protects the blinds and allows the lighting device to be transported easily.

FIG. 10 illustrates two further lighting devices having a pyramidal shape -100- and a cylindrical shape -200-.

Although the invention has been described in relation to preferred embodiments these must not be regarded as restricting the invention, which will be defined by the broadest interpretation of the following claims.

1. A mobile lighting device for the illumination of interiors, comprising a three-dimensional geometrical body which has translucent or transparent faces, in the interior of which there is a light source, and in that its lateral faces have blinds of the venetian-blind type with horizontal slats.

2. A lighting device according to claim 1, wherein the slats of the blinds have holes or zones on their surfaces which allow light to pass from the interior of the lighting device.

3. A lighting device according to claim 1, wherein it has at least one control means to vary the spatial orientation of the slats.

4. A lighting device according to claim 3, wherein it comprises at least one control means to raise and lower the blinds.

5. A lighting device according to claim 1, wherein the blinds of slats are located within a space defined by two transparent sheets.

6. A lighting device according to claim 1, wherein it has a translucent upper end member.

7. A lighting device according to claim 1, wherein the upper end member is a laminar member supported on projections from a skeleton shaping the lighting device.

8. A lighting device according to claim 1, wherein it is a parallelepipedic shape.

9. A lighting device according to claim 1, wherein it is of cylindrical shape.

10. A lighting device according to claim 1, wherein it has an essentially pyramidal shape.
